(19) United States
(12) Patent Application Publication
(10) Pub. No.: US 2004/0197726 A1
(43) Pub. Date: Oct. 7, 2004

(54) Clip type orthodontic anchor

(76) Inventors: Shouichi Miyawaki, Okayama (JP); Isao Koyama, Hyogo (JP); Teruko Yamamoto, Okayama (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/649,363

(22) Filed: Aug. 27, 2003

(30) Foreign Application Priority Data
Aug. 27, 2002 (JP) 2002-247243

(51) Int. Cl. A61C 3/00

(52) U.S. Cl. 433/21

(57) ABSTRACT

A clip type anchor for orthodontic treatment comprises piercing portions for piercing a skin and fitting a bone, and a connection portion connecting the piercing portions to each other. The connection portion biases the piercing portions toward the bone. A connection portion is substantially U-like shaped, and piercing portions fit an inside and an outside of an alveolar bone, thereby fixing the anchor to the alveolar bone. In an anchor comprising piercing portions for piercing a skin and fitting a bone, and a connection portion connecting the piercing portions to each other, the connection portion biases the piercing portions so as to either increase or decrease a distance between the piercing portions.

### BACKGROUND OF THE INVENTION

1. Field of the Invention

The present invention relates to an anchor (an implant anchor) for orthodontic treatment.

2. Related Art

In orthodontic treatment, in order to apply orthodontic force to one tooth and move it, a supporting point (anchorage), which resists the orthodontic force, is required in another portion.

Wire, rubber, coil springs, etc. are known as materials for applying the orthodontic force to a mal-positioned tooth or teeth, and a method using another tooth or an extra-oral appliance as an anchorage is known. The mal-positioned tooth or teeth are moved by the aforesaid means using the anchorage.

Since the Multibracket Appliance was developed early in the 20th century, an orthodontic treatment using an edgewise appliance or the like has been a standard for therapy to move teeth three-dimensionally.

In this orthodontic treatment, it is also important to ensure the anchorage at the time of movement of teeth. Generally, a molar or another tooth other than a mal-positioned tooth is required as an anchorage. However, in this manner, a problem may occur in that a tooth other than the tooth to be moved is unexpectedly moved.

In addition, an extra-oral anchorage method requiring an anchorage in the head, the back of a cervix or another portion of a patient is generally used as a reinforced anchorage method. However, in this method, a burden on the patient is significant.

Thus, the above-mentioned two conventional methods for ensuring an anchorage in orthodontic treatment involve significant indefinite factors for obtaining a good therapeutic result, thereby limiting the methods to some cases.

Since Branemark et al. developed an osseointegrated implant for compensation for a lack of a dental root in prosthetic dentistry, an orthodontic treatment using the implant as an anchorage has been practiced.

However, the implant is expensive, and in some cases, an anchorage for the orthodontic treatment does not require such strength as the implant has. Therefore, in the last five years, a screw or a mini-plate for fixation of bone in therapy of bone fracture or others has been used as an anchorage in orthodontic treatment.

For example, Japanese Patent Laid-open Nos. Hei. 11-164843 and 2001-187071 disclose the above, wherein a screw is anchored through a cortical bone of a jaw to a bone marrow, and a plate or a wire is fixedly supported on the screw.

As mentioned above, an implant anchor such as a screw and a plate not only enhances the applicability of orthodontic treatment, but also improves the reliability thereof, and thus, the implant anchor is about to be accepted as a curative means.

However, for applying the conventional implant anchor such as a screw and a plate to a patient, a surgical procedure is required. That is, since a gingiva is cut out and the screw is introduced into the bone marrow, incision or ablation of mucous membrane and surgical treatment reaching a cancellous bone are necessary, resulting in great organic invasion. The orthodontic treatment using a screw or a plate has a higher risk to a patient, such as osteomyelitis or other harmful side effects caused by surgery or a medication, in comparison with orthodontic treatment without them. Moreover, these surgical procedures require anatomical knowledge about locations of tooth roots and the like as well as surgical skills.

As such, the above requires a long time as well as high surgical skills. Furthermore, the conventional implant anchor cannot be used as the anchorage for an orthodontic treatment immediately after it is anchored, because the orthodontic treatment is carried out after the portion where the anchor is anchored recovers. Moreover, acceptable sites for anchoring the implant in an oral cavity are anatomically limited. Therefore, it is difficult to consider that such implant anchors come to be used by many orthodontists and general dentists in many areas.

In view of the forgoing, desired is an implant anchor which can be used in many dentistry cases (from an easy case to a difficult case), has effect equal to or better than the extra-oral appliance in place of the conventional implant anchor such as a screw and mini-plate, and enables orthodontic treatment according to a treatment plan without extensive cooperation of a patient.

### SUMMARY OF THE INVENTION

An object of the invention is to provide an implant anchor as a stable orthodontic anchor, which is easily attached and detached by any dentist, and which is applicable for various cases from an easy case to a difficult case, in place of the conventional implant anchor such as a screw or a plate.

To attain the object, a new anchor (implant anchor) according to the invention comprises multiple piercing portions for piercing a gingiva and mucous membrane and fitting a bone, and a connection portion connecting the piercing portions to each other. The connection portion biases the piercing portions toward the bone.

This implant anchor is a clip type orthodontic anchor, which is applied into an oral cavity so as to pinch or press a jaw. The implant anchor clamps surfaces of a (cortical) bone or presses the bone from the inside like a prop, thereby being used as an anchorage. The anchor has such a simple structure that the piercing portions for piercing a gingiva or mucous membrane and fitting a bone are connected by the connection portion and biased toward a bone by the connection portion can be easily fixed to a surface of a bone, and reduces adverse effects on an organism. The anchor, unlike the conventional screw and mini-plate, does not drill a bone, whereby it may be applied in any area. Further, the anchor does not require such a surgical treatment as ablation of gingiva and/or mucous membrane, thereby relieving a patient of anxiety about side effects caused by drilling a bone.

Because the anchor also reduces labor of a surgeon, and the anchor is not introduced into a bone, safety of treatment can be greatly enhanced. In addition, the anchor enables orthodontic treatment without complicated mechanisms even in difficult cases such as a skeletal open bite, an asymmetrical occlusal plane, and unbalancing arrangement of molars on left and right sides.

Further, it can lower the cost of orthodontic treatment significantly, because treatment with the anchor provides effective results without edgewise appliances, headgears, or intermaxillary elastics.

Since the connection portion is substantially U-like shaped so as to bias the piercing portions toward a bone, the biasing force for fixing the anchor can be efficiently applied onto the piercing portions, thereby stably supporting the anchor.

The anchor can be fixed to a surface of a bone using its simple structure, and reduce an organic harmful influence.

Because the anchor can reduce labor of a surgeon, and the anchor is not introduced into a bone, safety of treatment can be greatly enhanced. Further, orthodontic treatment using the implant anchor can be easily carried out without complicated mechanisms even in difficult cases such as a skeletal open bite, an asymmetrical occlusal plane, and unbalancing arrangement of molars on left and right sides. It can lower the cost of orthodontic treatment significantly, because treatment with the anchor can provide effective results without edgewise appliances, headgears, or intermaxillary elastics.

Since the above-mentioned piercing portions fit an alveolar bone on the buccal side and on the lingual or palatal side so as to be fixed to the alveolar bone, an impact exerted on the bone by application of the anchor is lightened. The anchor can be fixed to a surface of a bone using its simple structure, and make small an influence to an organism.

The anchor comprises piercing portions for piercing a skin and fitting a bone, and a connection portion connecting the piercing portions to each other, and the connection portion biases the piercing portions so as to either increase or decrease a distance between the piercing portions. Therefore, the anchor can be fixed to a surface of a bone using its simple structure, and can be applied in various positions in an oral cavity.

These, other, and further objects, features and advantages will be more fully apparent from the following description.

### BRIEF DESCRIPTION OF THE DRAWINGS

FIG. 1 is a perspective view of a clip type orthodontic anchor 1 according to a first embodiment of the present invention applied in an oral cavity.

FIG. 2 is a plan view of the anchor 1 as in the above.

FIG. 3 is a perspective view of the anchor 1 as in the above.

FIG. 4 is a side view of the anchor 1 as in the above.

FIG. 5 is a front view of the anchor 1 as in the above.

FIG. 6(a) is a plan view of the anchor 1 as in the above, showing the elastic deformation thereof.

FIG. 6(b) is a perspective view of the anchor as in the above held by pliers 5, and FIG. 6(c) is a perspective view of the anchor as in the above held by pliers 5 with another means.

FIG. 7 is a rear side view partly in section of an alveolar and gingiva applied with the anchor 1 as in the above.

FIG. 8(a) is a plan view of another clip type orthodontic anchor 1 according to a second embodiment of the present invention, FIG. 8(b) is a perspective view of the same, and FIG. 8(c) is a side view of the same.

FIG. 9 is a perspective view of the anchor 1 of the second embodiment, applied in an oral cavity.

FIG. 10(a) a plan view of a rod 2 of another orthodontic anchor 1 according to a third embodiment of the present invention, separated from piercing members 15, FIG. 10(b) is a side view of the rod 2, and FIG. 10(c) is a front view of the rod 2.

FIG. 11(a) is a side view of the piercing member 15 for the anchor 1 of the third embodiment, FIG. 11(b) is a front view of the same, and FIG. 11(c) is a perspective view of the same.

FIG. 11(d) is a perspective view of a modified piercing member 15b attached to a modified rod 2 of the anchor 1 of the third embodiment.

FIG. 12 is a plan view of the anchor 1 of the third embodiment having the pressed piercing members 15.

FIG. 13(a) is a perspective view of a ring-like clip type orthodontic anchor 21 according to a fourth embodiment of the present invention, and FIG. 13(b) is a perspective view of the same anchor 21 when it is folded.

FIG. 14(a) is a front view of a clip type orthodontic anchor 31 according to a fifth embodiment of the present invention, and FIG. 14(b) is a side view of the same.

FIG. 15 is a perspective view of the same.

FIG. 16(a) is a side view of a clip type orthodontic anchor 41 according to a sixth embodiment of the present invention, and FIG. 16(b) is a perspective view of the same retainer 41.

FIG. 17 is a perspective view of the anchor 41 of the sixth embodiment, applied in an oral cavity.

FIG. 18(a) is a front view of a clip type orthodontic anchor 51 according to a seventh embodiment of the present invention, and FIG. 18(b) is an arrow sectional view of the line A-A in FIG. 18(a).

FIG. 18(c) is a sectional view of a tooth, alveolar and gingiva applied with the orthodontic anchor 51 of the seventh embodiment.

FIG. 19 is a plan view of a palate applied with a clip type orthodontic anchor 61 according to an eighth embodiment of the present invention.

FIG. 20(a) is a plan view of the anchor 61 of the eighth embodiment having two piercing portions 63, FIG. 20(b) is a plan view of the anchor 61 of the eighth embodiment modified so as to have four piercing portions 63, FIG. 20(c) is a plan view of the anchor 61 of the eighth embodiment modified to be curved, and FIG. 20(d) is a plan view of the anchor 61 of the eighth embodiment modified to be U-like shaped.

FIG. 21(a) is a plan view of a clip type orthodontic anchor 71 for a maxilla according to a ninth embodiment of the present invention.

FIG. 21(b) is a plan view of a maxilla applied with the retainer 71 of the ninth embodiment.

FIG. 21(c) is a plan view of a part of maxilla with the retainer 71 when it is shortened.

FIG. 22(a) is a plan view of a clip type orthodontic anchor 79 for the mandible according to a tenth embodiment of the present invention.

FIG. 22(b) is a plan view of the mandible with the aforementioned anchor 79.

FIG. 22(c) is a plan view of an example of the aforementioned anchor 79 modified by shortening.

FIG. 23(a) is a plan view of another clip type orthodontic anchor 80.

FIG. 23(b) is a plan view of another clip type orthodontic anchor 90.

### DETAILED DESCRIPTION OF THE INVENTION

Embodiments of the invention will be explained with reference to the drawings.

[First Embodiment]

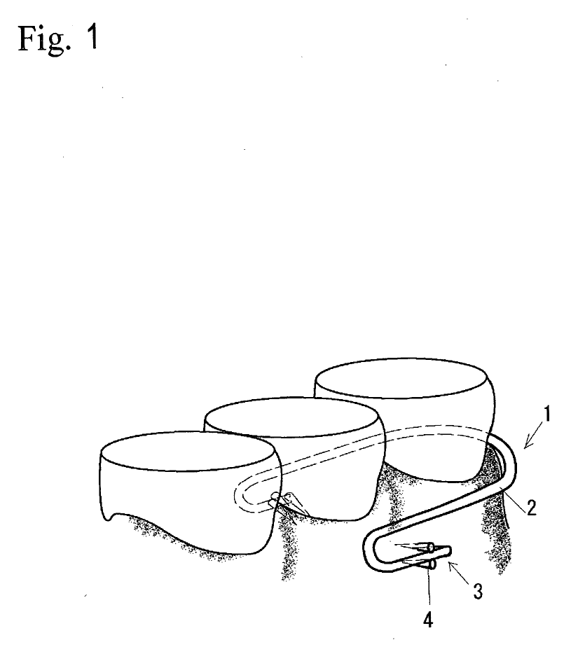

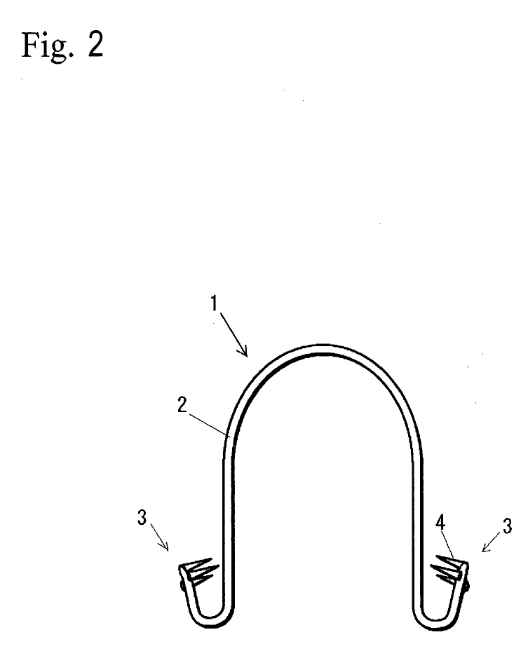

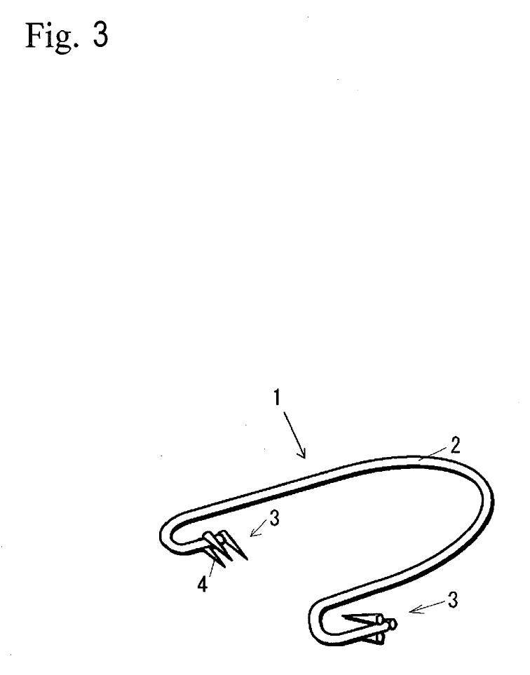

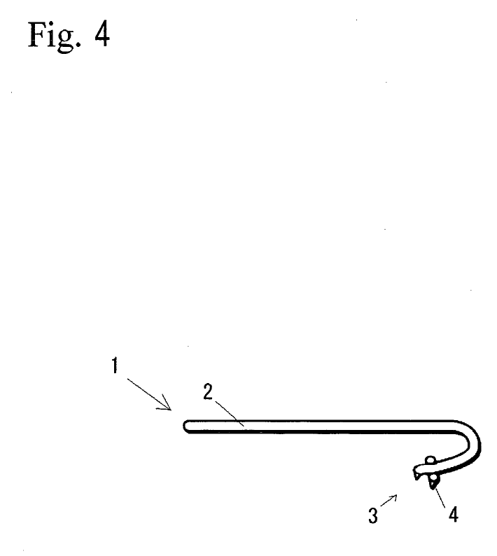

An orthodontic anchor 1 according to a first embodiment of the invention shown in FIGS. 1 to 7 will be explained.

The orthodontic anchor 1 is used as an anchorage for orthodontic treatment in an oral cavity, wherein it is fixed to an alveolar bone, or a bone, through a gingiva and mucous membrane, i.e., a skin.

The anchor 1 comprises a connection rod 2, which is substantially arcuate or U-like shaped in a plan view, and turned at both end portions. In other words, the rod 2 is curved at the middle and both end portions thereof.

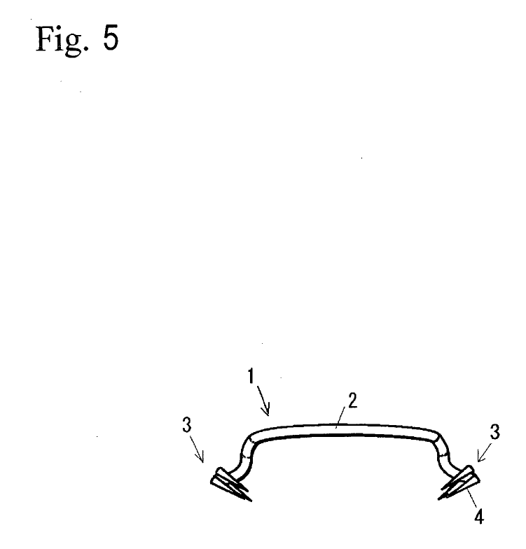

When viewed in front as shown in FIG. 5, both the turned end portions of the rod 2 are extended outward from the U-like shaped main portion thereof at about 45 degrees so that, when the anchor 1 is applied in the oral cavity so as to arrange the main portion horizontally as shown in FIG. 1, later-discussed needles 4 provided on the ends of the rod 2 are oriented substantially perpendicular to a surface of an alveolar bone.

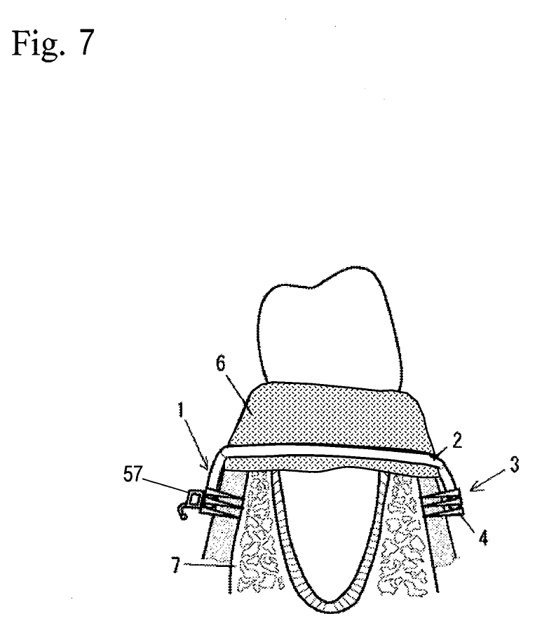

Both the end portions of the rod 2 serve as piercing portions 3 each of which is provided with a needle 4 or substantially parallel needles 4 for piercing the skin. In other words, the two piercing portions 3 are connected to each other via the rod 2, or the U-like shaped main portion of the rod 2 serves as a connection portion of the anchor 1 for connecting the piercing portions 3 to each other. As shown in FIG. 1 or 7, when the anchor 1 is applied so as to position the U-like shaped portion of the rod 2 against a gingival surface, the piercing portions 3 are separately arranged inside and outside of a dentition, and the needles 4 are inclined downward as shown in FIG. 5 so as to facilitate piercing the skin (gingva and mucous membrane) and fitting the bone (alveolar bone).

The rod 2 requires such strength and biasing force as to stably fix the needles 4 to the alveolar bone and may be made of elastic materials such as stainless steels, titanium, titanium alloys, and cobalt-chromium alloys.

The cross sectional shape of the rod 2 may be a circle, an ellipse or a rectangle with rounded corners. If the sectional shape of rod 2 is a circle, by reducing the diameter of the sectional circle of the rod 2, the feeling of unfitness of the rod 2 in the oral cavity can be reduced, and the oral cavity can be surely kept clean. If the cross sectional shape of the rod 2 is an ellipse or a rectangle having a width of 3 mm, for example, by setting a thickness thereof at 1 mm or less, the feeling of unfitness can be reduced and at the same time the oral cavity can be surely kept clean.

In the anchor 1, multiple piercing portions 3 are provided on each side. The piercing portions 3 are provided on the ends of the connection portion 2 and connected via the connection portion 2.

The shape of the rod 2 is not limited. The rod 2 of the anchor 1 may be reshaped according to the condition of the site in the oral cavity where the anchor is applied.

In the forgoing, the configuration of the rod 2 is not limited to the above embodiment. What is necessary to the rod 2 is just to have enough strength and biasing force, to cause little unfitness feeling in the oral cavity, and to keep the oral cavity clean.

In the anchor 1, portions expect for the tips of the needles 4 of the piercing portions 3 may be formed smoothly so as to reduce adverse influence on the tongue and mucous membrane inside the oral cavity.

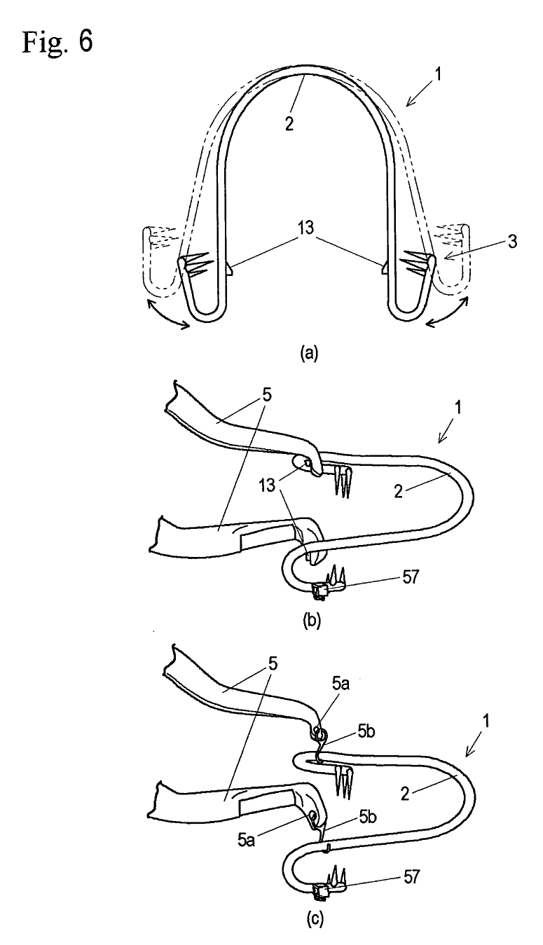

When the anchor 1 is free from any force, the U-like shaped main portion of the rod 2 is narrow as shown in substantial lines in FIG. 6(a). The rod 2 is elastically deformable so that it may be forcibly widened so as to move the piercing portions 3 away from each other (increase the distance between the piercing portions 3) as shown in phantom lines in FIG. 6(a). When force is applied to the anchor 1 so as to widen the U-like shaped main portion of the rod 2, force occurs in the rod 2 so as to narrow the main portion of the rod 2, that is, bias the opposite piercing portions 3 toward each other.

As shown in FIGS. 6(a) and 6(b), a pair of projections 13 are formed on the rod 2. Each of the projections 13 is disposed adjacent to each folding portion of the rod 2 between each piercing portion 3 and the main portion of the rod 2. As discussed later, the projections 13 are hooked to pliers 5 and the anchor 1 is applied into the oral cavity. Hooks 5b may be interposed between the pliers 5 and the anchor 1 as shown in FIG. 6(b).

As shown in FIG. 6(b) and (c), a wire guide 57 may be fixed onto the outside of the rod 2 adjacent to one of the piercing portions 3. The wire guide 57 guides a wire for orthodontic treatment. The wire guide 57 comprises a tube, through which the wire is passed, and a hook on which the wire is hooked.

For applying the anchor 1 in the oral cavity, the anchor 1 is held with the pair of pliers 5 or the like. As shown in FIG. 6(b), the tips of pliers 5 are fit onto the respective projections 13 and opened to some degree so as to widen the U-like main portion of the rod 2, that is, to increase the distance between the piercing portions 3. Alternatively, as shown in FIG. 6(c), the pliers 5 may be provided at tips thereof with holes 5a, and the rod 2 may be hooked thereto by the hooks 5b engaged into the holes 5a.

In the oral cavity, the middle portion of the rod 2 is in contact with the distal gingiva edge of dentition, one piercing portion 3 is located close to the external gingiva surface, i.e., the gingiva on the labial or buccal side, and the other piercing portion 3 is located close to the inner gingival surface, i.e., the gingiva on the lingual or palatal side. The pliers 5 are then removed from the projections 13, and thereby the rod 2 having the biasing force tends to restore so as to narrower the U-like shaped main portion of rod 2, and the piercing portions 3 move toward each other, that is, the distance between the piercing portions 3 is reduced. Consequently, the needles 4 of the respective piercing portions 3 pierce the gingiva and mucous membrane and fit the inner and outer surfaces of alveolar bone.

As shown in FIG. 7, when the application of the anchor 1 is complete, the anchor 1 clamps a jaw by the needles 4 pressed against the alveolar bone.

As mentioned above, the rod 2 biases the piercing portions 3 toward each other, that is, toward the alveolar bone so that the needles 4 of the piercing portions 3 penetrate a gingiva and mucous membrane 6 and fit at the tips thereof a cortical bone 7, thereby fixing the anchor 1 to the alveolar bone.

As shown in FIG. 7, in order to fix the anchor 1 to the mandible stably, the piercing portions 3 are arranged to incline the needles 4 downward because the upper part of an alveolar bone has an upwardly narrowed curved shape, so that the needles approximately perpendicularly fit to its surface. For the maxilla, the anchor 1 may be vertically reversed so as to incline the needles 4 upward substantially perpendicularly to the alveolar bone surface of the maxilla.

In this way, protruding members represented by the needles 4 fit at tips thereof several portions of the surface of the cortical bone so as to fix the orthodontic anchor 1 to the bone, thereby reducing surgical invasion. The anchor 1 used in orthodontic treatment lightens burdens on a patient and a surgeon. Diametrical reduction of the needles 4 leads to further lightening effect.

The needles 4 are introduced into the gingiva or mucous membrane 6 so as to fit the cortical bone. Pure titanium, titanium alloy, other commonly used metal material, plastics, ceramics, etc. can be used for material of the needles 4. Any material can be used if it has high biocompatibility.

With respect to the shape of piercing portions 3, in this embodiment, the needles 4 are sectionally circular; however, other shapes may be used. Further, the needles 4 according to this embodiment are disposed in parallel to each other; however, the needles 4 may be alternatively arranged radially in the piercing portion 3 or in a shape of a truncated cone. Moreover, the rod 2 of the anchor 1 may be reshaped adaptively to the target site or the conditions of oral cavity. Therefore, the shape of the anchor 1 is not limited to the above-mentioned configurations.

[Second Embodiment]

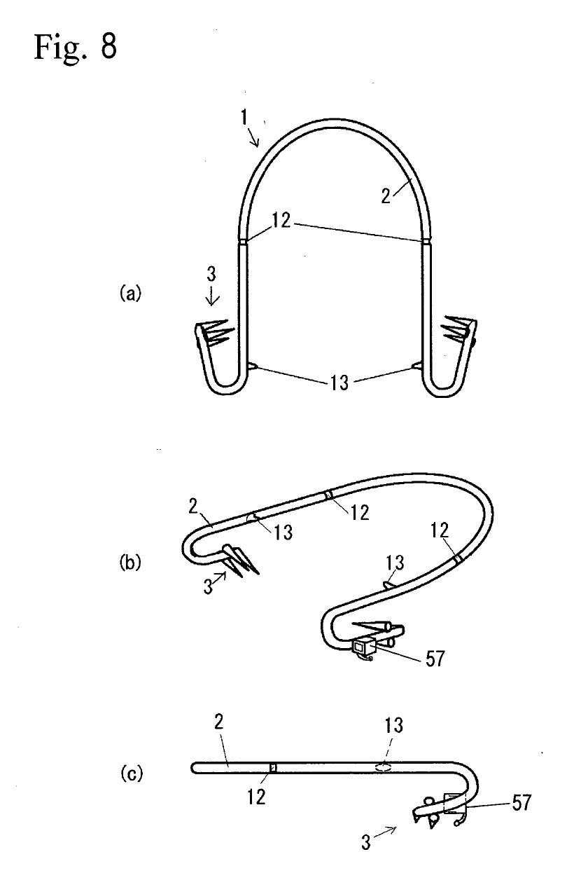

Another orthodontic anchor 1 according to a second embodiment of the invention shown in FIGS. 8(a), (b), (c) and 9 will be explained.

An anchor 1 of the second embodiment shown in FIG. 8 has the same configurations as the anchor 1 of the first embodiment except for a pair of grooves 12 formed on a rod 2. Each of the grooves 12 is disposed on an intermediate portion between the middle curve portion and the turned edge portion in the U-like shaped main portion of the rod 2, so that the grooves 12 are opposed to each other. Projections 13 are provided similarly to those of the anchor 1 of the first embodiment. They are arranged near respective turning edges of the rod 2 with a U-like opening therebetween, and symmetrically with respect to the center line of the anchor 1.

When the anchor 1 is widened by pliers or the like, the projections 13 are engaged to the respective pliers so as to make it easy to hold the anchor 1 by the pliers, thereby facilitating application or removal of the anchor 1 into and from the oral cavity.

The grooves 12 are formed around a periphery of the rod 2. A ligature wire or another elastic member can be latched on the respective grooves 12 so as to be strung between the grooves 12, thereby increasing the biasing force of the rod 2. In other words, wire or elastic is fitted onto the rod 2 so as to enhance the force for pressing the piercing portions 3 of the anchor 1 against a bone. Alternatively, more than two grooves 12 may be provided in the rod 2.

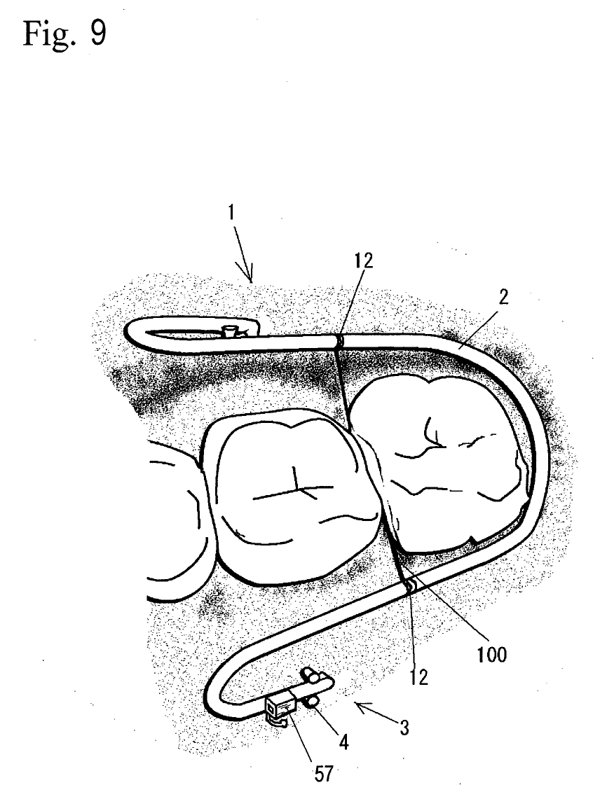

As shown in FIG. 9, a ligature wire 100 is fastened onto the grooves 12 and strung between the grooves 12 so as to increase the biasing force in a direction of closing the U-like shaped main portion of the rod 2, thereby enhancing the force for pinching a jaw and preventing the anchor 1 from slipping off the jaw.

In FIG. 9, fist, second and third molar teeth are arranged from the distal end of a dentition, and the anchor 1 is provided to be anchored at the second molar, that is, the outer piercing portion 3 is fit onto the external gingiva of the second molar on the labial or buccal side, and the inner piercing portion 3 onto the inner gingiva of the second molar on the lingual or palatal side. The middle curved portion of the rod 2 is fitted onto the distal edge of gingiva of the dentition so that the rod 2 clamps the dentition from the inside and the outside. The ligature wire 100 is disposed between crowns of first and second molars. The ligature wire 100 can be diametrically so small as to be disposed in a narrow gap between teeth.

The ligature wire 100 having suitable tension may be selected for adjusting the biasing force of the rod 2 to the piercing portions 3.

Next, an orthodontic treatment using the anchor 1 of the second embodiment will be explained.

The anchor 1 is previously provided with a member for guiding a wire for orthodontic treatment, such as a wire guide 57, for example, a tube, a bracket or a hook. Surface anesthesia is applied to a target site in an oral cavity. The anchor 1 is then applied and pressed onto the site by using the ligature wire 100, for example.

In a case where no tooth is extracted from a patient having a dentition of permanent teeth, the anchor 1 is arranged so as to clamp a jaw toward an alveolar bone. In a case where a tooth is extracted from a patient having a dentition of permanent teeth, the anchor 1 is arranged in the centrifugal direction from a socket of the extracted tooth in the reverse direction from that of FIG. 9.

[Third Embodiment]

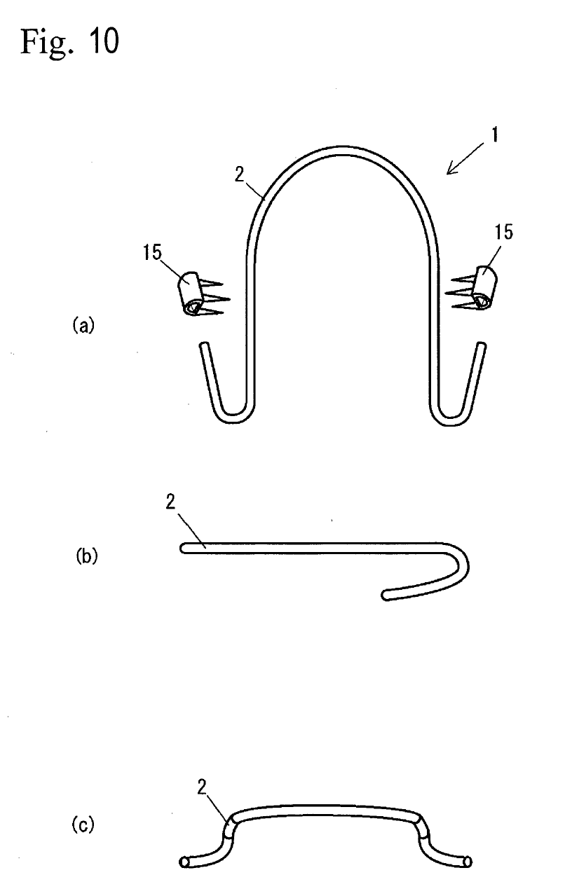

Another anchor 1 according to a third embodiment shown in FIGS. 10(a), 10(b), 10(c), 11(a), 11(b), 11(c), 11(d) and 12 will be explained. The anchor 1 of the third embodiment is provided with piercing members 15 separated from the rod 2 instead of the piercing portions 3. The piercing members 15 are attached onto the rod 2 so as to constitute the anchor 1.

Since the piercing members 15 fitting a cortical bone are separated from the rod 2, the piercing members 15 may be adjusted in location relative to the rod 2, and they may be fixed to the rod 2 at a given location.

In the case where the rod 2 is flexibly re-shapable corresponding to the condition of application, when the piercing members 15 are not provided on the rod 2, the rod 2 can easily be reshaped into a suitable shape.

After the rod 2 is reshaped adaptively to the application condition, the piercing members 15 are located on the rod 2 adaptively to the application condition and fixed thereon. Therefore, the anchor 1 can easily be configured corresponding to its application condition.

Each of the piercing members 15 comprises a tube 16 and needles 4 affixed to the tube 16.

The tube 16 is configured wherein needles 4 are fixed to a lower surface thereof. The rod 2 is inserted into the tubes 16 and joined to the tubes 16. In this way, the piercing members 15 can be coupled to the rod 2 at given positions, and the directions of the needles 4 of the piercing members 15 can also be adjusted.

Any member can serve as the tube 16 if it can be coupled to the rod 2 and can connect the needles 4 and the rod 2.

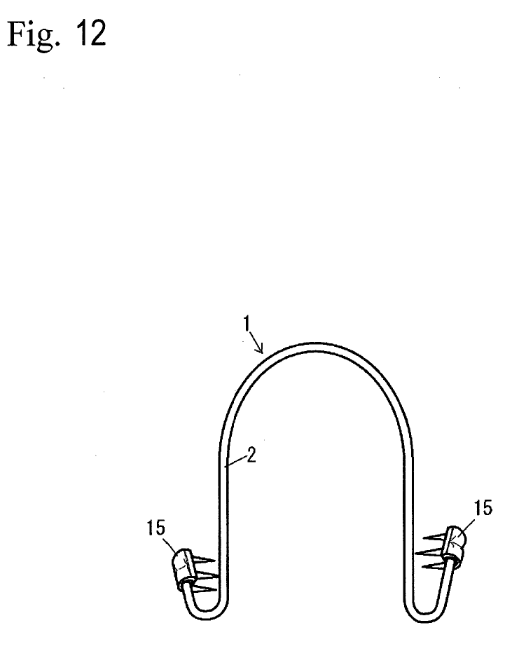

With respect to a manner for attaching the piercing members 15 onto the rod 2, as shown in FIG. 12, the tubes 16 of the piercing members 15 may be pressed so as to fix the piercing members 15 to the rod 2. As another means for coupling the piercing members 15 to the rod 2, welding or adhesives may be used.

Alternatively, the piercing members 15 may be prevented only from escaping from the rod 2 but may be rotatably fitted on the rod 2. When the anchor 1 is applied, the piercing members 15 can be rotated to arrange angles of the needles 4 so as to evenly fit the needles 4 to a bone.

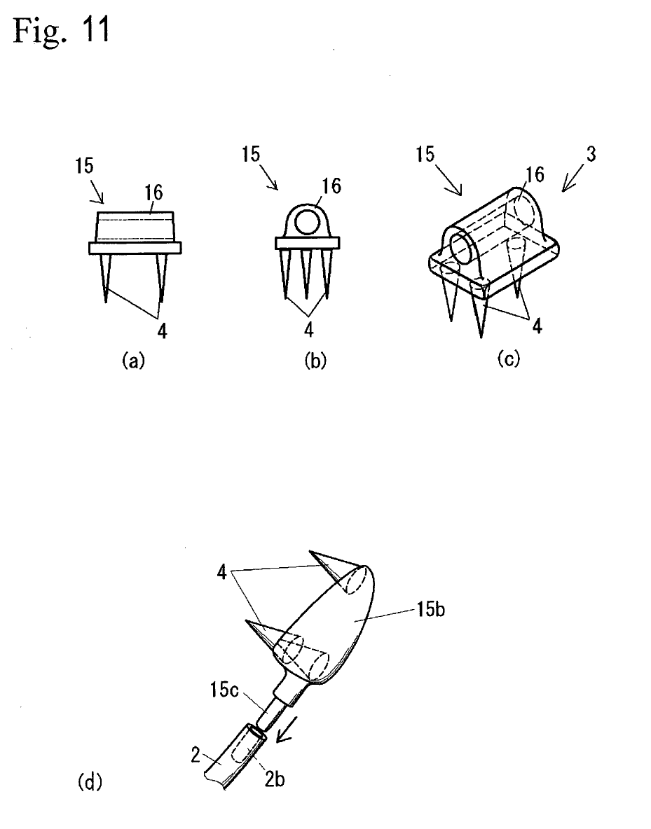

As shown in FIG. 11(d), the piercing members may be inserted into the ends of the rod 2 and fixed thereto. In this regard, at one end of the piercing member 15b fixedly provided with needles 4, an inserted projecting portion 15c is formed. At the ends of the rod 2, insertion holes 2b are provided. To fix the piercing members 15b to the rod 2, the inserted projecting portions 15c are inserted into the respective insertion holes 2b. The piercing members 15b may be fixed to the rod 2 by pressing in, welding, engaging, screwing, or an adhesive.

In this way, the piercing portions serve as male means, and the connection portion serve as female means, thereby increasing options of joint means, and options of material for the connection portion and the piercing portions. For example, the piercing portions may be made of titanium, ceramic or the like. If the piercing portion is made of ceramic, its surface may be treated by hydroxyapatite.

[Fourth Embodiment]

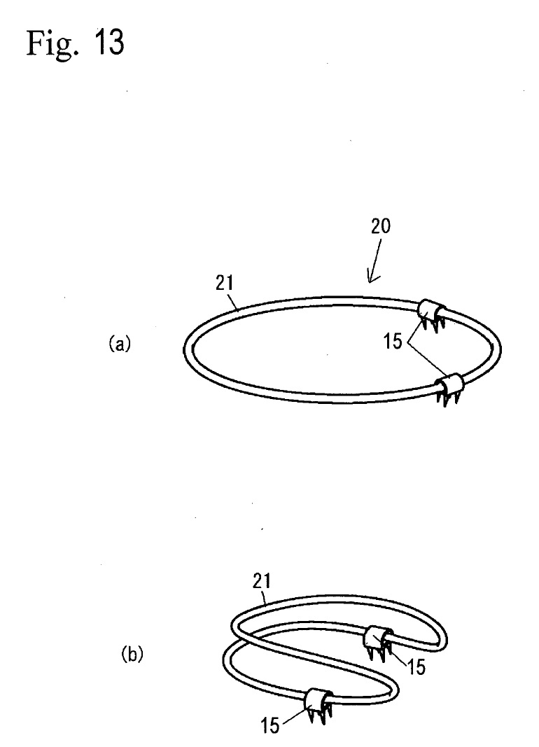

A clip type orthodontic anchor 20 according to a fourth embodiment of the invention shown in FIGS. 13(a) and 13(b) will be explained.

The orthodontic anchor 20 according to the fourth embodiment is provided with a ring-like rod 21, which is passed through the tubes of the above-mentioned piercing members 15. When the anchor 20 is going to be applied, the rod 21 is reshaped corresponding to the target site, and then the piercing members 15 are located, and the anchor 20 is applied.

Before the anchor 20 is applied into an oral cavity, a tube, a bracket and a hook or the like such as the above-mentioned wire guide 57 is coupled thereto in advance.

For one example of reshape of the rod 21, the rod 21 may be bent downward so as to be made into a boat-like form, and the piercing members 15 may be located facing each other at lower portions of the rod 21. In this way, the piercing members 15 are sufficiently biased by respective U-like shaped portions of the rod 21 even when the sectional diameter of the rod 21 is small.

Alternatively, as shown in FIG. 13(b), the rod 21 may be folded, and the piercing members 15 are located, thereby constituting an anchor. The anchor 20 can be firmly applied by sufficient force of the folded rod 21.

In some cases, it is also possible to cut away an unnecessary portion of the rod 21 afterward. These modifications can vary depending on the application condition of the anchor 20 and should not be limited.

[Fifth Embodiment]

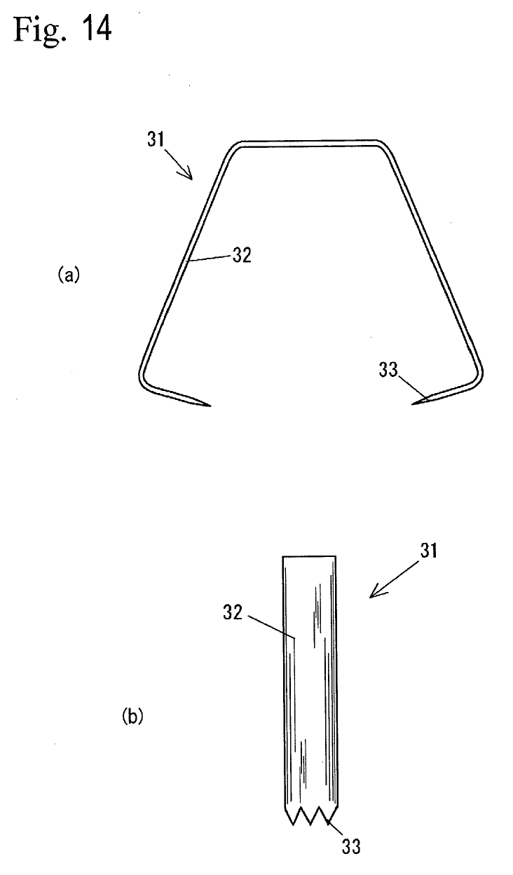

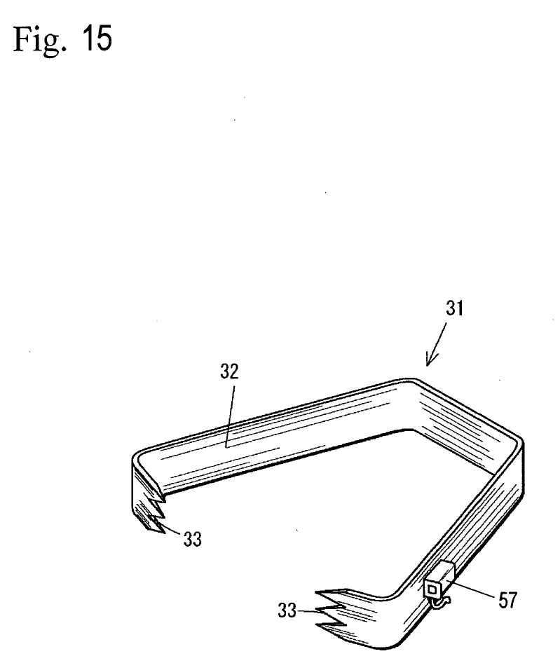

A clip type orthodontic anchor 31 according to a fifth embodiment of the invention shown in FIGS. 14(a), 14(b) and 15 will be explained.

The anchor 31 of the fifth embodiment is made of a plate wherein a connection portion and piercing portions are integrally formed. The plate serving as the anchor 31 is bent so that end portions of the plate serve as the piercing portions 33, and the other portion of the plate serves as the connecting portion 32. As shown in FIG. 14(a), the connecting portion 32 of the anchor 31 is substantially U-like or C-like shaped in a plan view. The piercing portions 33 are extended inward in an open area. The connection portion 32 and the piercing portion 33 form an angle of about 90 degrees.

The utmost end of the piercing portion 33 is formed in a chevron-like shape, and sharpened edges thereof penetrate the gingiva or mucous membrane to fit the cortical bone. The piercing portions 33 are turned toward each other, so that the alveolar bone is held between the piercing portions 33 by the restoring force of the anchor 31.

At the time of applying the anchor 31, the span between the piercing portions 33 is widened by pliers or the like, and the anchor 31 is fitted to a bone. In this case, the piercing portions 33 are configured to be also used as projections to be easily held by pliers.

The anchor 31 is applied in a state where the open side thereof is forcibly widened, whereby elastic biasing force is exerted on the anchor 31 in such a direction that the distance between the piercing portions 33 decreases. Therefore, the piercing portions 33 are pressed against a bone so as to fix the anchor 31 to the bone. Similarly to other anchors, a tube, bracket, hook or the like, such as the wire guide 57 for leading a wire for orthodontic treatment is coupled to the anchor 31 in advance.

[Sixth Embodiment]

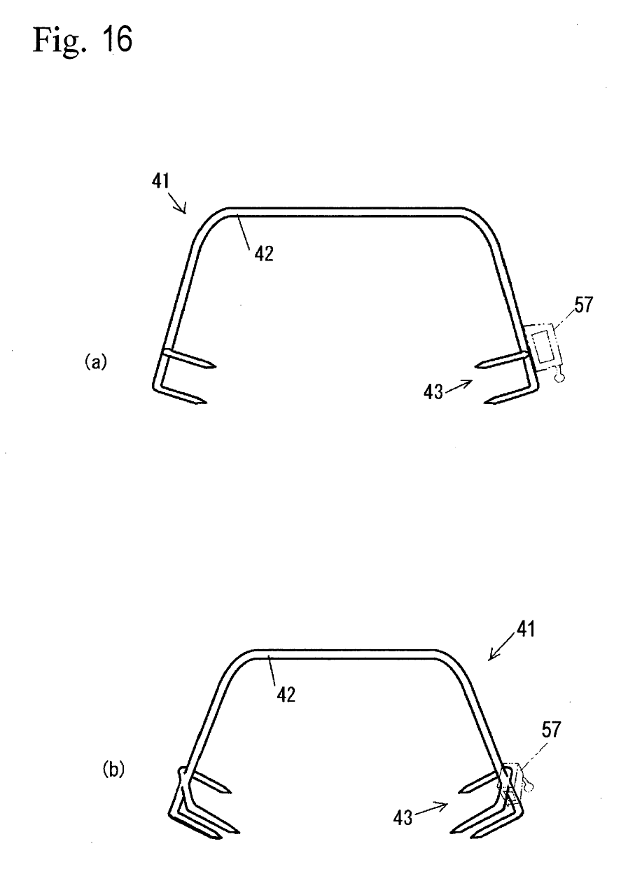

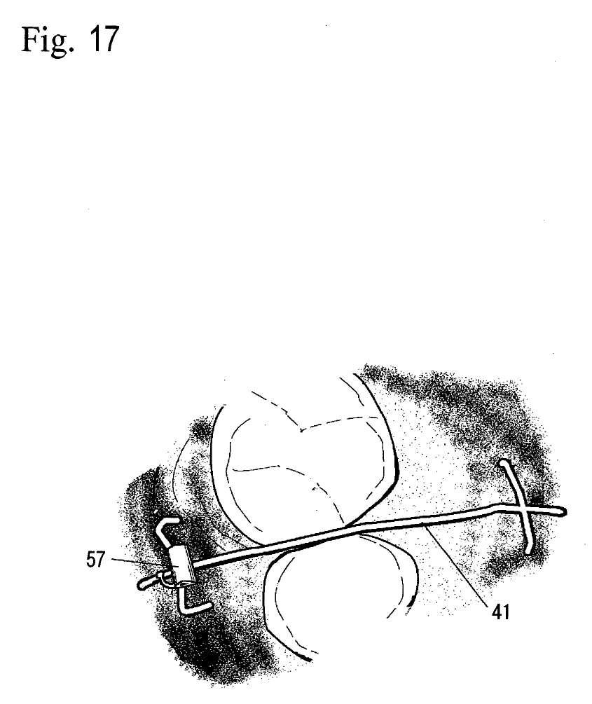

An orthodontic anchor 41 according to a sixth embodiment of the invention shown in FIGS. 16(a), 16(b) and 17 will be explained. The anchor 41 according to the sixth embodiment is made of a rod-like member 42, which connects trident ends 43 to each other. The rod-like member 42 is U-like, C-like or V-like shaped when viewed in front. The ends 43 provided on both ends of the rod-like member 42 are turned toward each other. A tube with a hook 42b is fixed onto the end 43.

In the anchor 41, each of the ends 43 forms three needle-like members having sharp tips, so as to pierce a gingiva and reach a bone.

In the sixth embodiment, the anchor 41 has elastic force for biasing the ends 43 to a bone, thereby being fixed to the bone. Alternatively, for anchoring the anchor 41, while the anchor 41 is applied, the ends are forcibly pressed to a bone so as to plastically reshape the anchor 41, and the ends 43 are introduced at tips thereof into the bone so as to fix the anchor 41 to the bone. In this case, the ends 43 are introduced into the bone so as to increase an area in contact between the anchor 41 and the bone, and the ends 43 are pressed to the bone by the biasing force of the rod-like member 42, thereby firmly fixing the anchor 41 to the bone.

Because the anchor 41 of the sixth embodiment is made of the thin rod-like member 42, which may be disposed between teeth, a space for application thereof can be reduced. Thus, a range where the anchor can be applied is expanded. Before applied, the anchor 41 is provided thereon with a tube, hook, bracket or the like such as the wire guide 57 for leading a wire.

[Seventh Embodiment]

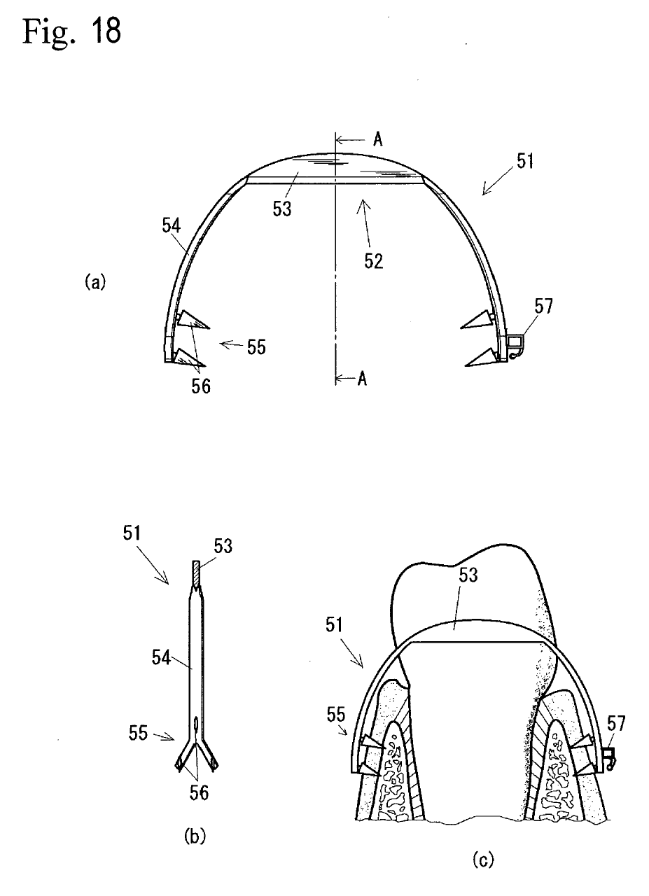

A clip type orthodontic anchor 51 according to a seventh embodiment of the invention shown in FIGS. 18(a), 18(b) and 18(c) will be explained.

The anchor 51 according to the seventh embodiment comprises a connection portion 52, piercing portions 55 and a tube with a hook 57. At the ends of the connection portion 52, the piercing portions 55 are provided inward, and at one end thereof, the tube with the hook 57 is provided outward.

The connection portion 52 is constituted by a plate 53 at the middle thereof and left and right arms 54 connecting thereto. The plate 53 is sharpened at an edge thereof when viewed in side. Therefore, when the anchor 51 is applied between teeth, the edge of the plate 53 is so thin as to be easily fitted.

Since the connection portion 52 is provided with the plate 53 at the middle thereof, the anchor 51 can be disposed in a narrow space, and the strength of the connection portion 52 is increased. Thus, the anchor 51 can easily be applied even between teeth or another site, and increase biasing force applied onto the piercing portions 55, thereby firmly fixing the anchor to a bone.

The piercing portions 55 is made of three needles 56 turned inward. The tips of the three needles 56 are arranged as vertexes of a triangle in side view.

When the anchor 51 is applied, the needles 56 of the piercing portions 55 pierce a gingiva or mucous membrane and fit an alveolar bone, whereby the anchor 51 is fixed to the alveolar bone.

The wire guide 57 which is a tube with a hook is disposed on an end portion of the arm 54 opposite to the piercing portion 55 so as to connect a wire or the like for orthodontic treatment to a portion of the anchor 51 adjacent to the piercing portion 55 for fixing the anchor 51 to an alveolar bone.

[Eighth Embodiment]

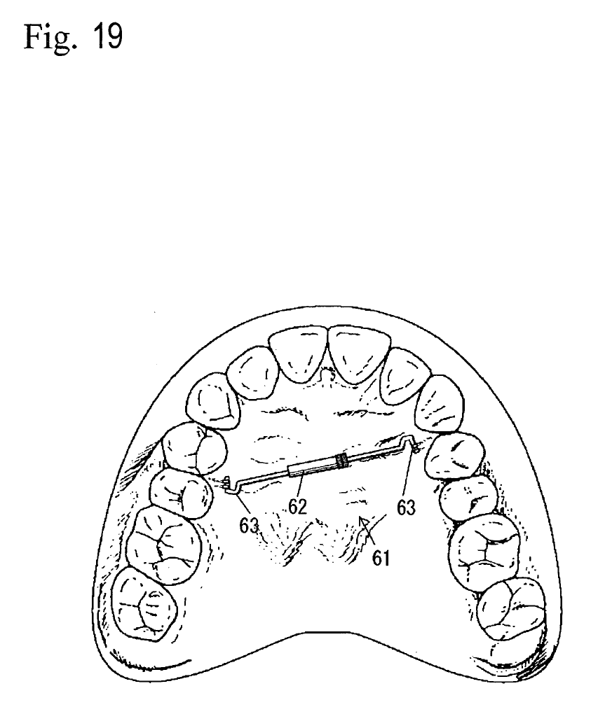

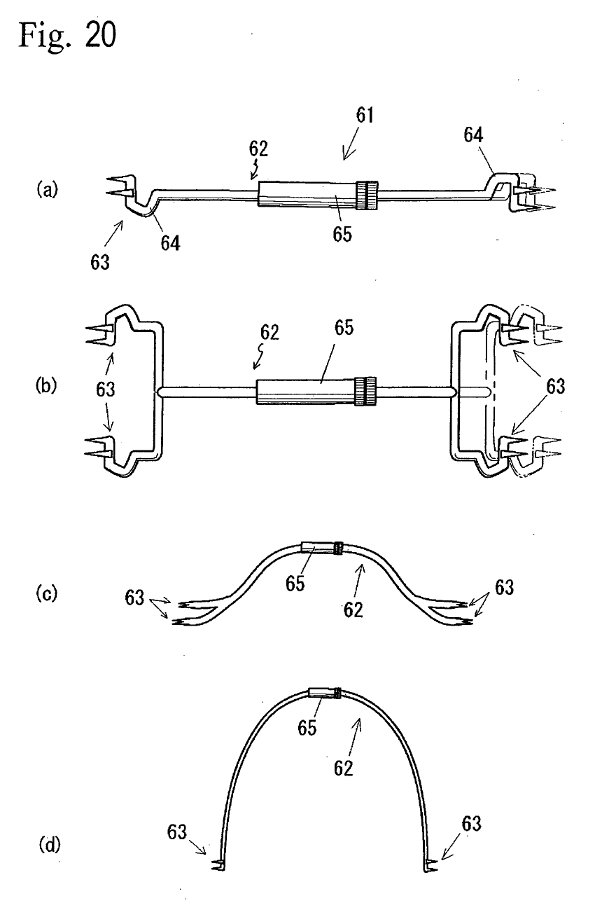

A clip type orthodontic anchor 61 according to an eighth embodiment of the invention shown in FIGS. 19, 20(a), 20(b), 20(c) and 20(d) will be explained.

The anchor 61 according to the eighth embodiment comprises a connection portion 62 and piercing portions 63. The connection portion 62 is provided with an adjusting portion 65 for adjusting the length of the connection portion 62. The piercing portions 63 are connected to the connection portion 62 through a curved portion 64 provided in the connection portion 62.

The connection portion 62 is provided with the length-adjusting portion 65. For constructing the length-adjusting portion 65, a member fixed to a rod having the piercing portion 63 on one end engages with another member fixed to a rod having the piercing portion 63 on the other end by screwing or the like, so that the members are axially movable relative to each other. The screwing degree of the length-adjusting portion 65 is adjusted so as to adjust the length of the connection portion 62.

Needles of the piercing portions 63 are disposed outward in an extensional direction of the connection portion 62. The anchor 61 of the eighth embodiment is disposed between bones outside of the anchor 61, thereby being anchored between the bones.

Between mucous membranes in a palate, the piercing portions 63 are pressed into the mucous membranes so as to fix the anchor 61. The curved portion 64 of the anchor 61 is elastically reshaped so as to adjust the force for pressing the piercing portions 63.

The anchor 61 is used as an anchor applied to a palate. Thus, the anchor 61 is provided with a tube, bracket, hook or the like in advance. The anchor 61 is located on the palate and the piercing portions 62 are biased toward alveolar bones, whereby the anchor 61 is fixed to the bone.

In the anchor 61, one piercing portion 63 may be on each of the ends as shown in FIG. 20(a), or alternatively, each of the ends of the connection portion 62 may bifurcate so as to form the piercing portions 63 on respective tips as shown in FIG. 20(b), thereby increasing points where the anchor fits a bone so as to enhance the holding force of the anchor.

Alternatively, as shown in FIG. 20(c), an anchor having a U-like shaped connection portion 62 having piercing portions 63 outward at its ends may be used. The connection portion 62 biases the piercing portions 63 at both ends so as to widen the space therebetween. Sharp portions of the piercing portions 63 are disposed outward, and the piercing portions 63 are biased to alveolar bones by the connection portion 62. In the anchor shown in FIG. 20(c), the lower piercing portions 63 are longer (extended further outward) than the upper piercing portions 63.

Alternatively, as shown in FIG. 20(d), an anchor having a U-like shaped connection portion 62 having piercing portions 63 outward at its ends may be used for the mandible. In the anchor shown in FIG. 20(d), the connection portion 62 has so large a U-like shape as to prevent interference with the tongue.

[Ninth Embodiment]

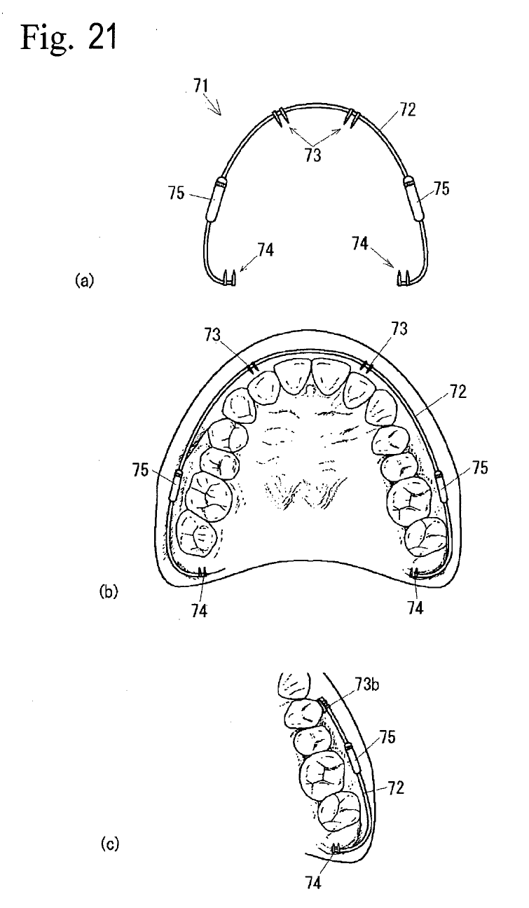

A clip type orthodontic anchor 71 according to a ninth embodiment of the invention shown in FIGS. 21(a), 21(b) and 21(c) will be explained.

The orthodontic anchor 71 is used for the maxilla, and formed along the shape of an outer maxillary gingiva or mucous membrane.

The anchor 71 comprises a connection portion 72 and piercing portions 73 and 74. The connection portion 72 is provided with an adjusting portion 75 for adjusting the length of the connection portion 72. The connection portion 72 is provided with the piercing portions 73 on its substantially middle portion, and with the respective piercing portions 74 on its ends. The ends of the anchor 71 are curved inward so that the piercing portions 74 hold tubers of the maxilla.

Accordingly, the anchor 71 can be applied onto the whole of the maxilla. The adjusting portion 75 provided between the piercing portion 73 and the piercing portion 74 adjusts the interval between the piercing portion 73 and the piercing portion 74 so as to adjust the size of the connection portion 72, thereby enhancing the force for holding the anchor.

The adjusting portion 75 is provided for adjusting the length of the connection portion 72 similarly to the above-mentioned embodiment. The adjusting portion 75 may adopt an ordinary adjusting manner.

Needles of the piercing portions 73 and 74 are disposed inward in the anchor 71 having a horseshoe shape in plan view. The needles of the piercing portions 73 and 74 are attached at an angle of about 90 degrees with respect to a bone surface. Corresponding to the shape of alveolar projection onto the anchor 71 is applied, the extensional angles of the needles of the piercing portions 73 and 74 may be adjusted suitably.

As shown in FIG. 21(c), an anchor may be provided with a piercing portion 74 on one end, and the other end thereof may be connected to a tooth through a bracket 73b so as to serve as an anchorage. The connection portion 72 may be provided with an adjusting portion 75 for adjusting its length.

[Tenth Embodiment]

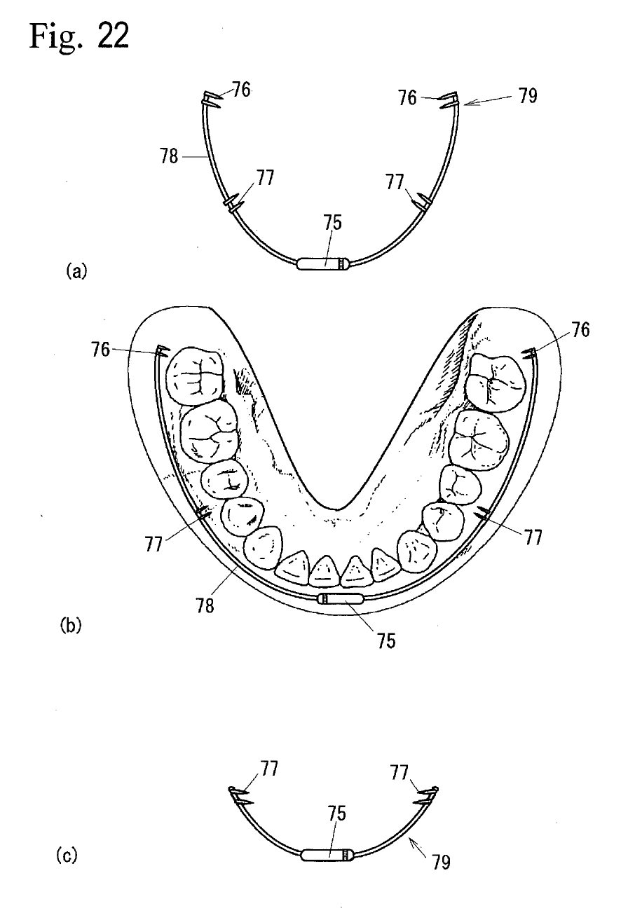

A clip type orthodontic anchor 79 according to a tenth embodiment of the invention shown in FIGS. 22(a), 22(b) and 22(c) will be explained.

The orthodontic anchor 79 according to the tenth embodiment is used for the mandible, and formed along the shape of an outer mandibular gingiva or mucous membrane.

The anchor 79 comprises a connection portion 78 and piercing portions 76 and 77. The connection portion 78 is provided with an adjusting portion 75 for adjusting the length of the connection portion 78. The piercing portions 76 and 77 are disposed inward in the horseshoe anchor 79 substantially perpendicular to the extensional direction of the connection portion 78.

The anchor 79 is provided with piercing portions 76 on its ends, and with the adjusting portion 75 at the substantially middle. Each of the piercing portions 77 is disposed between the adjusting portion 75 and each of the piercing portions 76.

The anchor 79 is applied onto a mandibular alveolar projection from the outside so as to press the piercing portions 77 and 76 against a gingiva or mucous membrane. Accordingly, the piercing portions 77 and 76 fit alveolar bones, thereby anchoring the anchor 79 into the mandible.

Alternatively, the anchor 79 may be modified into such a form as shown in FIG. 22(c). In FIG. 22(c), this anchor 79 is provided with piercing portions 77 on its ends. The piercing portions 77 fit an alveolar bone so as to hold the anchor 79. Between the piercing portions 77, an adjusting portion 75 is disposed for adjusting the distance between the piercing portions 77.

The piercing portions 77 of this anchor 79 has sharp portions disposed inward at sharp angles from the connection portion.

[Other Embodiments]

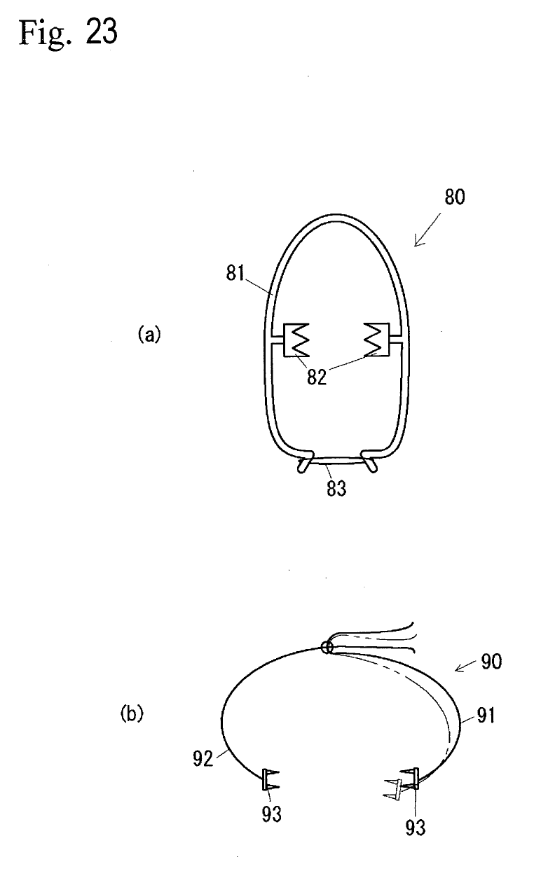

Other clip type orthodontic anchors in accordance with FIGS. 23(a) and (b) will be explained.

An anchor 80 shown in FIG. 23(a) comprises a U-like shaped connection portion 81 having piercing portions 82 facing each other at intermediate portions thereof. A wire 83 or the like is wound around open side edges of the connection portion 81, thereby adjusting the biasing force onto the piercing portions 82.

An anchor 90 shown in FIG. 23(b) comprises connection portions 91 and 92 intersecting each other. The connection portions 91 and 92 are rotatable relative to each other around the intersecting point of the connection portions 91 and 92. Each of the connection portions 91 and 92 is fixedly provided with a piercing portion 93 on one end of each. Force applied for closing the other ends of the connection portions 91 and 92 serves as the force for biasing the piercing portions 93 toward each other.

Having described the specific embodiments, it is understood by those skilled in the art that various changes and modifications may be made in the invention without departing from the spirit and scope of the subjoined claims.

1. A clip type orthodontic anchor, comprising:
piercing portions for piercing a gingiva and/or mucous membrane and fitting a bone; and
a connection portion connecting the piercing portions to each other, wherein the connection portion biases the piercing portions toward the bone.

2. The clip type orthodontic anchor as set forth in claim 1, wherein the connection portion is substantially U-like shaped so as to bias the piercing portions toward the bone.

3. A clip type orthodontic anchor, wherein the anchor fits an alveolar bone on the lingual or palatal side, and fits of an alveolar bone on the labial or buccal side, thereby being anchored to the alveolar bone.

4. A clip type orthodontic anchor, comprising:
piercing portions for piercing a gingiva and/or mucous membrane and fitting a bone; and
a connection portion connecting the piercing portions to each other, wherein the connection portion biases the piercing portions so as to increase a distance between the piercing portions.

5. A clip type orthodontic anchor, comprising:
piercing portions for piercing a gingiva and/or mucous membrane and fitting a bone; and
a connection portion connecting the piercing portions to each other, wherein the connection portion biases the piercing portions so as to decrease a distance between the piercing portions.

6. A clip type orthodontic anchor, comprising:
piercing portions for piercing a gingiva and/or mucous membrane and fitting a bone; and
a biasing member for biasing the piercing portions toward the bone.
